(19) United States
(12) Patent Application Publication
(10) Pub. No.: US 2019/0348724 A1
(43) Pub. Date: Nov. 14, 2019

(54) CHARGING DEVICE, AND ONBOARD POWER SOURCE DEVICE

(71) Applicant: Panasonic Intellectual Property Management Co., Ltd., Osaka (JP)

(72) Inventor: NOBUAKI SATOH, Kanagawa (JP)

(21) Appl. No.: 16/523,707

(22) Filed: Jul. 26, 2019

Related U.S. Application Data
(63) Continuation of application No. PCT/JP2018/004543, filed on Feb. 9, 2018.

(30) Foreign Application Priority Data
Mar. 9, 2017 (JP) 2017-045093
Dec. 11, 2017 (JP) 2017-237163

(51) Int. Cl. H01M 10/615; B60L 50/50; B60L 1/02; B60L 58/27; H01M 10/44; H01M 10/48; H01M 10/6571; H01M 10/66; H02J 7/00

(52) U.S. Cl. CPC H01M 10/615; B60L 50/50; B60L 1/02; B60L 58/27; H01M 10/443; H01M 2220/20; H01M 10/6571; H01M 10/66; H02J 7/0052; B60L 2240/36; B60L 2240/545; H01M 10/48

(57) ABSTRACT

A charging device includes a battery charger, a resistance heater, and a cooler. The battery charger is connected to an external power source and supplies electric power to a battery. The resistance heater is connected to the battery charger and converts electric power from the battery charger into heat. The cooler cools the battery charger and the battery with a cooling medium by causing the cooling medium to flow from the battery charger to the battery. When the charging device charges the battery under an environment of a predetermined temperature or lower, the battery charger supplies the electric power to the resistance heater, and heat generated in the battery charger is transmitted to the battery via the cooling medium.

### CROSS-REFERENCE TO RELATED APPLICATIONS

This application is a continuation of the PCT International Application No. PCT/JP2018/004543 filed on Feb. 9, 2018, which claims the benefit of foreign priority of Japanese patent application No. 2017-045093 and No. 2017-237163 filed on Mar. 9, 2017 and Dec. 11, 2017, respectively, the contents all of which are incorporated herein by reference.

### BACKGROUND

### 1. Technical Field

The present disclosure relates to a charging device and an onboard power source device.

### 2. Description of the Related Art

From the viewpoints of energy efficiency and charge-discharge characteristics, batteries used for electric vehicles and other apparatuses are usually desired to perform charging-discharging operation at a certain temperature (for example, 0° C.) or higher. Therefore, it is known that, when such a battery is charged under a low temperature environment, before starting the charging, the battery is heated to a certain temperature by using a resistance heater (for example, a positive temperature coefficient (PTC) heater) (for example, see Japanese Patent Unexamined Publication No. 2012-178899; referred as Patent Literature 1).

### SUMMARY

The present disclosure provides a charging device and an onboard power source device, which make it possible to achieve shorter charging time and higher energy-efficiency when a battery is charged under a low temperature environment.

A charging device according to an aspect of the present disclosure includes a battery charger, a resistance heater, and a cooler. The battery charger is to be connected to an external power supply and configured to supply electric power to a battery. The resistance heater is connected to the battery charger and configured to convert electric power from the battery charger into heat. The cooler is configured to cause a cooling medium to flow from the battery charger to the battery so as to cool the battery charger and the battery with the cooling medium. When the charging device charges the battery under an environment of a predetermined temperature or lower, the battery charger supplies the electric power to the resistance heater, and heat generated in the battery charger is transmitted to the battery via the cooling medium.

An onboard power source device according to an aspect of the present disclosure includes the charging device and the battery.

The charging device according to the present disclosure makes it possible to achieve shorter charging time and higher energy efficiency when the charging device charges the battery under a low temperature environment.

### BRIEF DESCRIPTION OF DRAWINGS

FIG. 1 is a diagram illustrating a configuration example of a charging device according to a first exemplary embodiment.

FIG. 2 is a diagram illustrating a configuration example of a cooler of the charging device according to the first exemplary embodiment.

FIG. 3 is a flow chart illustrating an example of operation of the charging device according to the first exemplary embodiment.

FIG. 4 is a schematic diagram illustrating a heat transfer path at the time when the charging device according to the first exemplary embodiment charges a battery under a low temperature environment.

FIG. 5 is a diagram illustrating a configuration example of a charging device according to a second exemplary embodiment.

FIG. 6 is a diagram illustrating a configuration example of a cooler of the charging device according to the second exemplary embodiment.

FIG. 7 is a flow chart illustrating an example of operation of the charging device according to the second exemplary embodiment.

FIG. 8 is a schematic diagram illustrating heat transfer paths at the time when the charging device according to the second exemplary embodiment charges a battery under a low temperature environment.

FIG. 9 is a diagram illustrating a configuration example of a charging device according to a third exemplary embodiment.

FIG. 10 is a diagram illustrating a configuration example of a cooler of the charging device according to the third exemplary embodiment.

FIG. 11 is a schematic diagram illustrating heat transfer paths at the time when the charging device according to the third exemplary embodiment charges a battery under a low temperature environment.

### DETAILED DESCRIPTION OF PREFERRED EMBODIMENTS

Commonly, a battery to be charged and discharged is used for itself as a power source for supplying electric power to the resistance heater. However, the battery is less sufficiently discharged under a low temperature environment, compared to a room temperature environment. Thus, electric power cannot be sufficiently supplied to the resistance heater, and accordingly it takes some time before starting the charging. Furthermore, the battery suffers a larger loss of energy under such a low temperature environment.

In this regard, Patent Literature 1 discloses a configuration in which it possible to supply electric power to a PTC heater from a battery charger connected to an external power source. However, from the viewpoints of, for example, size reduction, charging time reduction, and energy efficiency, there is room for improvement in the conventional technology disclosed in Patent Literature 1.

Hereinafter, preferred embodiments of the present disclosure will be described in detail with reference to the drawings. In the present specification and the drawings, constituents substantially having the same function are denoted by the same numerals, whereby the repetition of description about such constituents will be omitted.

### First Exemplary Embodiment

### Configuration of Charging Device

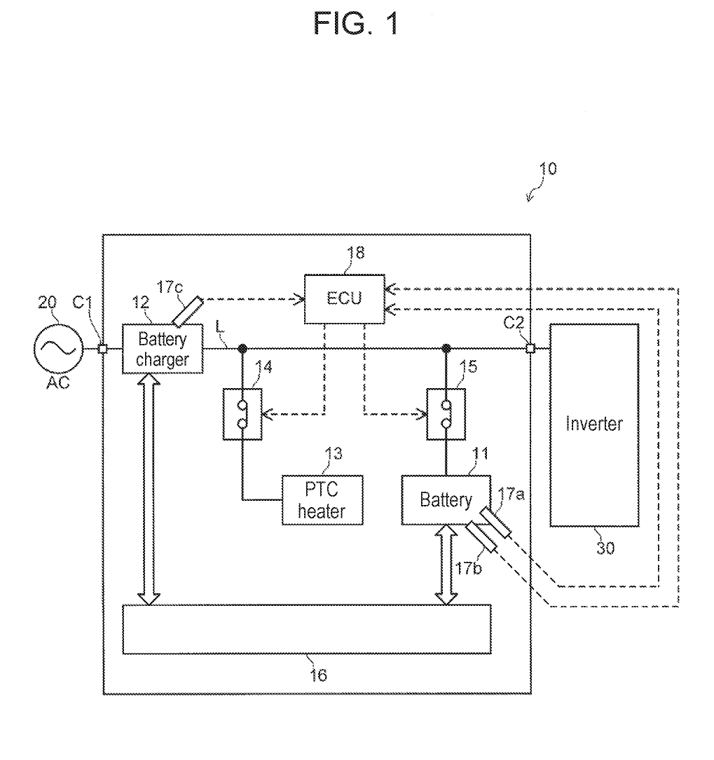

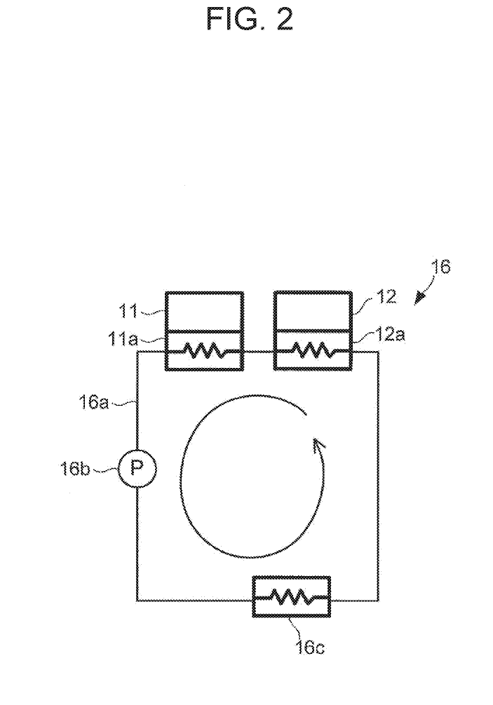

Hereinafter, a configuration example of a charging device according to a first exemplary embodiment will be described with reference to FIG. 1 and FIG. 2.

FIG. 1 is a diagram illustrating a configuration example of charging device 10 according to the present embodiment. In the drawing, L refers to a power line.

Charging device 10 according to the present embodiment is installed in a vehicle, for example, integrally with battery 11, and constitutes an onboard power source device.

Charging device 10 according to the present embodiment receives electric power from external power source 20 and charges battery 11. Charging device 10 according to the present embodiment is, for example, to be connected to external power source 20 via terminal C1, and connected to inverter 30 via terminal C2.

Charging device 10 includes battery charger 12, positive temperature coefficient (PTC) heater 13, switch 14 connected to heater 13, switch 15 to be connected to battery 11, cooler 16, voltage sensor 17a, temperature sensors 17b and 17c, and electronic control unit (ECU) 18.

When battery 11 is to be charged, external power source 20 gets connected to charging device 10 via a connecting plug, for example. External power source 20 is a commercial power source for supplying a single-phase alternative current (AC) power of 60 Hz and 200 V, for example, and supplies AC power to an input stage of battery charger 12.

Battery 11 may be any type of battery, such as a lithium ion secondary battery and a nickel hydride secondary battery. Battery 11 is connected to power line L, and can be charged and discharged via power line L. Note that the charging and discharging of battery 11 are performed, for example, by the opening/closing control of switch 15, based on a control signal from ECU 18.

Battery charger 12 converts the electric power received from external power source 20, and outputs the converted electric power to battery 11 and PTC heater 13. Battery charger 12 includes, for example, an AC/DC converter configured to convert AC power inputted from external power source 20 into direct current (DC) power, and a DC/DC converter configured to perform voltage conversion of the DC power.

Battery charger 12 operates based on the control signal from ECU 18, for example, operates so as to produce output electric power, an output voltage, or an output current, each being set based on the control signal from ECU 18.

Battery charger 12 is connected to battery 11 and PTC heater 13 via power line L, and is capable of supplying electric power to battery 11 and PTC heater 13, respectively. Power line L for supplying electric power from battery charger 12 is branched and connected to battery 11 and PTC heater 13. In other words, battery 11 and PTC heater 13 are connected in parallel on an output side of battery charger 12

PTC heater 13 is a resistance heater configured convert electric power supplied from battery charger 12 into heat so as to heat battery 11. When the battery 11 is charged or discharged under a low temperature environment, PTC heater 13 raises the temperature of battery 11. PTC heater 13 is arranged adjacent to a casing of battery 11 so as to sufficiently transfer heat to battery 11.

PTC heater 13 has the characteristics of consuming more power at a low temperature range, while consuming less power when electric resistance increases due to a temperature rise in a heater element. The use of PTC heater 13 as a resistance heater allows battery charger 12 to operate at approximately the maximum power output when battery 11 is to be charged under a low temperature environment, even in the case where battery charger 12 cannot perform a charging operation or even in the case where the amount of possible charging per unit time is small. Note that other types of resistance heaters may be used.

Switch 14 is arranged, on power line L, upstream of PTC heater 13 and downstream of a branch point at which power line L branches to battery 11, and switches electrical connections of battery charger 12 and PTC heater 13. In the present embodiment, when switch 14 is turned on, battery charger 12 can supply electric power to PTC heater 13.

Switch 15 is arranged, on power line L, upstream of battery 11 and downstream of another branch point at which power line L branches to PTC heater 13, and switches electrical connections of battery charger 12 and PTC heater 13. In the present embodiment, when switch 15 is turned on, battery charger 12 can supply electric power to battery 11.

As switch 14 and switch 15, any switch, such as a relay or a transistor, may be used. Note that switch 14 and switch 15 may be configured to be capable of not only the opening/closing of a circuit, but also step-by-step output adjustment.

Switching between ON and OFF modes of switch 14 and switch 15 is performed, for example, based on a control signal from ECU 18.

Cooler 16 is a common cooling system which cools both battery 11 and battery charger 12. Cooler 16 is configured to cool both battery 11 and battery charger 12 by using a common cooling medium (a coolant in the present embodiment).

FIG. 2 is a diagram illustrating a configuration example of cooler 16 of charging device 10 according to the present embodiment.

Cooler 16 is a cooling system that uses a coolant as the cooling medium, for example, and includes circulation circuit 16a, pump 16b, and radiator 16c.

In circulation circuit 16a, the cooling medium for exchanging heat with battery 11 and battery charger 12 circulates. In circulation circuit 16a, battery charger 12 and battery 11 are connected in series so that the common cooling medium flows from battery charger 12 to battery 11.

Pump 16b controls the flow of the cooling medium in circulation circuit 16a. Radiator 16c exchanges heat with the cooling medium, thereby dissipating heat from the cooling medium.

A casing of battery charger 12 is provided with heat sink 12a for exchanging heat with the cooling medium. Similarly, a casing of battery 11 is provided with heat sink 11a for exchanging heat with the cooling medium.

With this configuration, when battery 11 or battery charger 12 operates at a room temperature (for example, 0° C. or higher), cooler 16 absorbs heat from either or both of battery 11 and battery charger 12, and dissipates the heat via radiator 16c.

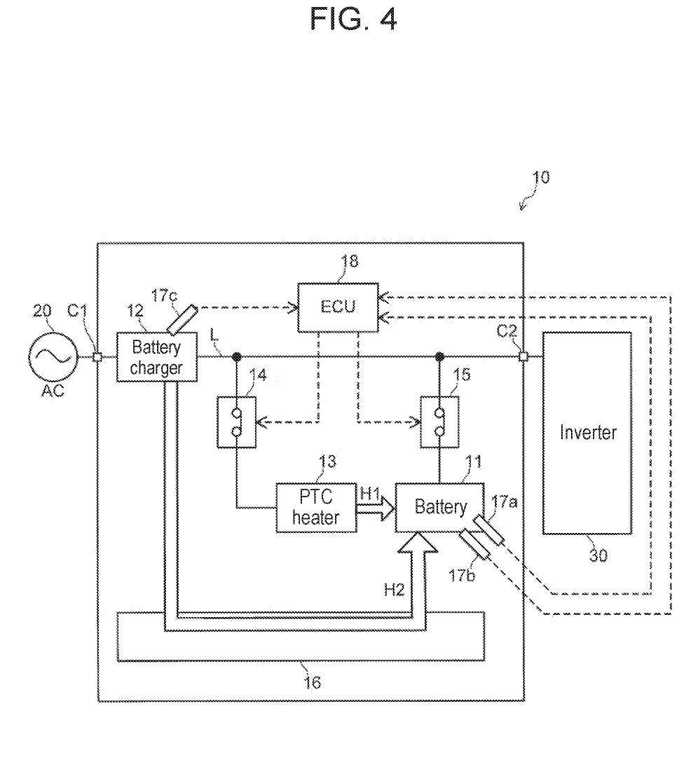

On the other hand, cooler 16 functions as a heat-transfer mechanism configured to, when battery 11 is to be charged under a low temperature environment (for example, 0° C. or lower), transmit heat generated in battery charger 12 to battery 11 via the cooling medium to raise the temperature of battery 11, before or immediately after the start of charging (see FIG. 4). Note that, when battery 11 is to be charged under a low temperature environment, a temperature relationship expressed by the following inequality (1) holds. At this time, due to the heat of battery charger 12, the temperature of the cooling medium is higher than the temperature of battery 11.

Temperature T1 of Battery Charger 12>Temperature T2 of Cooling Medium>Temperature T3 of Battery 11 Inequality (1)

As a matter of course, cooler 16 is not limited to the above-described configuration. For example, a switching valve may be provided to circulation circuit 16a, whereby a circulation path for the cooling medium in circulation circuit 16a can be switched in accordance with a temperature relationship among temperature T1 of battery charger 12, temperature T3 of battery 11, and temperature T2 of the cooling medium. Cooler 16 may be additionally provided with a cooling system which cools battery 11 only, or a cooling system which cools battery charger 12 only.

Furthermore, cooler 16 is not limited to have the cooling system in which a coolant is used as the cooling medium, but may have a cooling system in which air is used as the cooling medium.

Charging device 10 according to the present embodiment is provided with sensors, such as voltage sensor 17a configured to detect a cell voltage of battery 11, temperature sensor 17b configured to detect a temperature (for example, a temperature of the casing) of battery 11, and temperature sensor 17c configured to detect a temperature (for example, a temperature of the casing) of battery charger 12. Sensor signals detected by sensors 17a to 17c are transmitted to ECU 18. Note that each of sensors 17a to 17c may be a well-known sensor.

ECU 18 is an electronic control unit which integrally controls over the units of charging device 10. ECU 18 communicates with battery charger 12, switch 14, switch 15, cooler 16, sensors 17a to 17c, and units of a vehicle, thereby controlling these constituents or receiving data therefrom. Note that dotted lines in FIG. 1 indicate examples of signal paths.

ECU 18 according to the present embodiment controls charging and discharging of battery 11 by ON/OFF control over switch 15. Furthermore, by ON/OFF control over switch 14, ECU 18 controls a rise in the temperature of battery 11 caused by PTC heater 13. Furthermore, ECU 18 controls the flow of the cooling medium in circulation circuit 16a by controlling pump 16b of cooler 16. An example of operation of ECU 18 will be described later.

ECU 18 includes, for example, a central processing unit (CPU), a read only memory (ROM), a random access memory (RAM), an input port, and an output port. For example, the CPU refers to control programs and various data stored in the ROM and the RAM, whereby ECU 18 operates as described later. Note that the above-mentioned operation is not limited to processing by software, but may be realized by a dedicated hardware circuit.

### Operation Flow of Charging Device

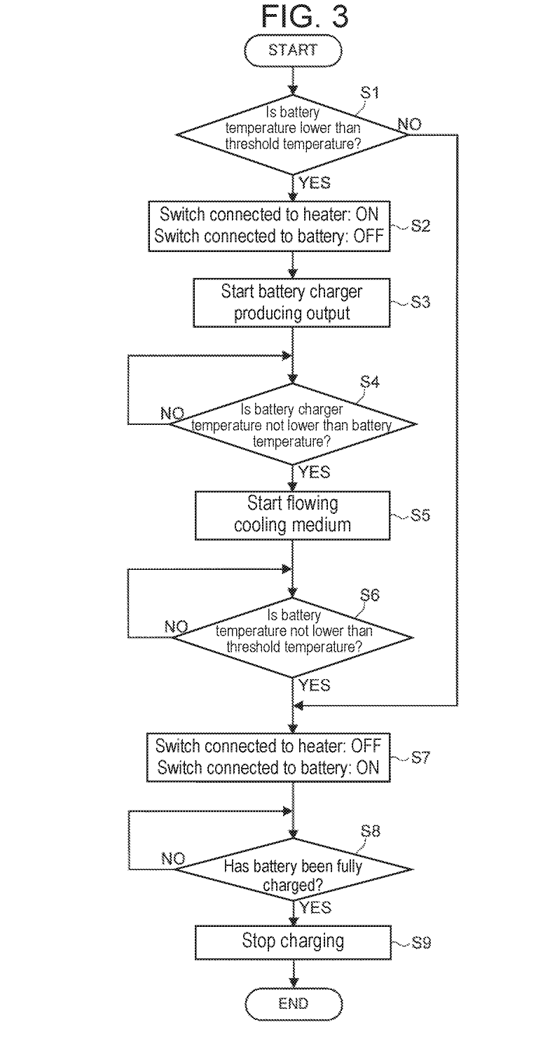

Hereinafter, an operation example of charging device 10 according to the present embodiment will be described with reference to FIG. 3 and FIG. 4.

FIG. 3 is a flow chart illustrating an example of operation of charging device 10 according to the present embodiment. The flow chart shown in FIG. 3 illustrates an operation performed by ECU 18 in accordance with a computer program, for example. This operation is performed, for example, when a connecting plug of external power source 20 gets connected to perform charging of battery 11.

FIG. 4 is a schematic diagram illustrating a heat transfer path taken when charging device 10 according to the present embodiment charges battery 11 under a low temperature environment. Note that, in FIG. 4, H1 refers to a path for transferring heat from PTC heater 13 to battery 11, and 112 refers to a path for transferring heat from battery charger 12 to battery 11.

From the viewpoints of energy efficiency and chargeable electric power, when battery 11 is to be charged under a low temperature environment, charging device 10 according to the present embodiment starts the charging operation after the temperature of battery 11 has risen to a predetermined temperature. At this time, as described above, charging device 10 raises the temperature of battery 11 by using both heat of PTC heater 13 and heat generated in battery charger 12 (see FIG. 4).

In Step S1, first, ECU 18 determines whether or not the temperature of battery 11 is lower than a threshold temperature (for example, 0° C.), based on, for example, a sensor signal from temperature sensor 17b. If ECU 18 determines that the temperature of battery 11 is lower than the first threshold temperature (YES in Step S1), ECU 18 proceeds to perform subsequent Step S2 to raise the temperature of battery 11. In contrast, when ECU 18 determines that the temperature of battery 11 is equal to or higher than the first threshold temperature (NO in Step S1), ECU 18 proceeds to perform Step S7 to charge battery 11 as usual.

Note that the threshold temperature is a threshold temperature for permitting charging, for example, and is set at a temperature allowing battery charger 12 to charge battery 11 at the maximum power output.

In Step S2, ECU 18 turns on switch 14 and turns off switch 15 so that battery charger 12 is electrically connected to PTC heater 13.

In Step S3, ECU 18 causes battery charger 12 to start producing output. Thus, PTC heater 13 starts raising the temperature of battery 11. Here, as described above, PTC heater 13 consumes more power at a low temperature, and hence, compared to the case where electric power is supplied to battery 11 under a low temperature environment, battery charger 12 can produce higher output, and accordingly the temperature (exhaust heat) of battery charger 12 is higher.

In Step S4, for example, ECU 18 determines whether or not the temperature of battery charger 12 (or the temperature of the cooling medium) is higher than the temperature of battery 11, based on a sensor signal from temperature sensor 17b and a sensor signal from temperature sensor 17c. When the temperature of the battery charger 12 (or the temperature of the cooling medium) is lower than the temperature of battery 11, ECU 18 waits until the temperature of battery charger 12 becomes equal to or higher than the temperature of battery 11 (NO in Step S4). Then, when ECU 18 detects that the temperature of battery charger 12 becomes equal to or higher than the temperature of battery 11 (YES in Step S4), ECU 18 proceeds to perform Step S5.

In Step S4, ECU 18 waits until the temperature of battery charger 12 increases and becomes equal to or higher than the temperature of battery 11. Here, it is configured such that, in order to heat battery 11 in minimal time, the common cooling medium starts flowing when the temperature of battery charger 12 becomes equal to or higher than the temperature of battery 11. However, ECU 18 may wait until the above-described state of Inequality (1) (Temperature T1 of Battery charger 12>Temperature T2 of Cooling medium>Temperature T3 of Battery 11) is established.

In Step S5, ECU 18 controls cooler 16 to cause the cooling medium to start flowing. Thus, the cooling medium of cooler 16 transfers heat generated in battery charger 12 to battery 11 (see FIG. 4).

In Step S6, ECU 18 waits until the temperature of battery 11 becomes equal to or higher than a threshold temperature (for example, 0° C.) (NO in Step S6). When ECU 18 detects that the temperature of battery 11 becomes equal to or higher than the threshold temperature (YES in Step S6), ECU 18 proceeds to perform subsequent Step S7.

In Step S7, ECU 18 turns off switch 14 and turns on switch 15 so that battery charger 12 is electrically connected to battery 11. Thus, battery 11 starts being charged.

Note that, in Step 7, before switching switch 15, ECU 18 may temporarily stop the output of battery charger 12. Alternatively, ECU 18 may turn on both switch 14 and switch 15 for a certain period of time so that both heating by PTC heater 13 and charging of battery 11 are performed.

In Step S8, ECU 18 waits until battery 11 is fully charged (NO in Step S8). When ECU 18 detects that battery 11 is fully charged (YES in Step S8), ECU 18 proceeds to perform subsequent Step S9.

In Step S9, ECU 18 stops the output of battery charger 12.

With the above-described flow, ECU 18 makes shorter the time elapsed before battery 11 starts being charged, and also efficiently transfers heat generated in battery charger 12 to battery 11, when battery 11 is to be charged under a low temperature environment. However, the above-described operation is merely an example, and various modifications may be made. As a matter of course, for example, ECU 18 may perform heating of battery 11 and charging of battery 11 at the same time.

As described above, in charging device 10 according to the present embodiment, a common cooling system is shared between battery 11 and battery charger 12, whereby, when battery 11 is to be charged under a low temperature environment, the temperature of battery 11 can be efficiently raised by making use of heat of battery charger 12. Thus, higher energy-efficiency and shorter charging time can be achieved.

Furthermore, in charging device 10 according to the present embodiment, battery charger 12 supplies electric power also to PTC heater 13, and thus, heat generated in battery charger 12 when the temperature of PTC heater 13 is increased can be effectively used to raise the temperature of battery 11. Furthermore, PTC heater 13 has the power consumption characteristic of consuming more power at a low temperature range, and thus, charging device 10 according to the present embodiment allows battery charger 12 to operate at approximately the maximum power output before the temperature of battery 11 is raised. Thus, still shorter charging time can be achieved.

### Second Exemplary Embodiment

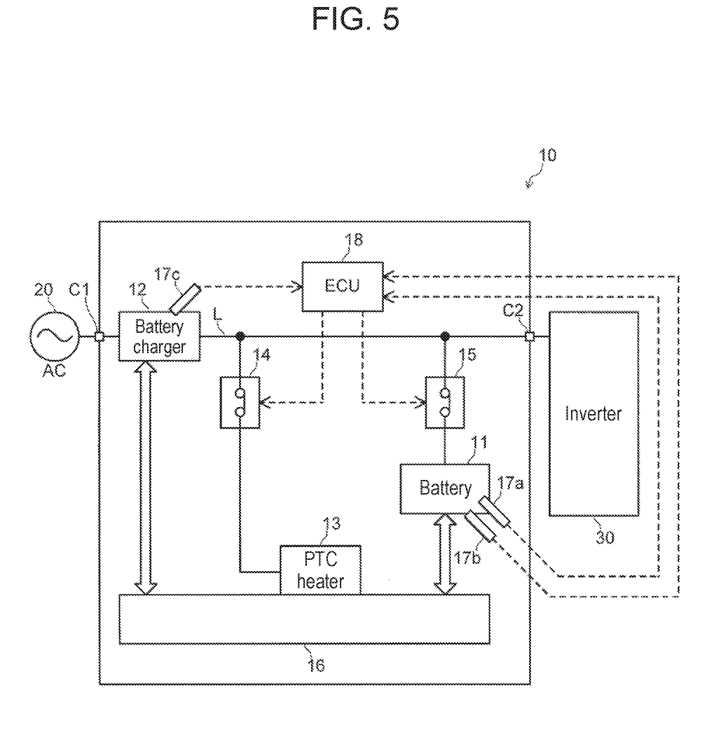

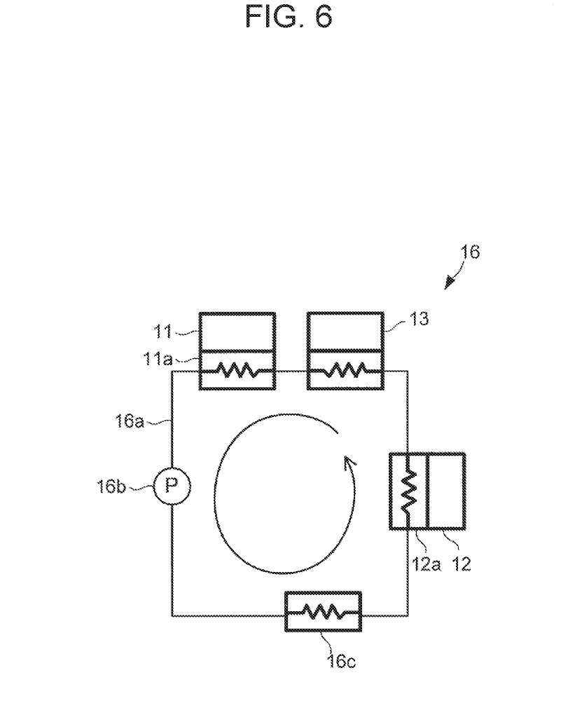

Hereinafter, a configuration example of charging device 10 according to a second exemplary embodiment will be described with reference to FIG. 5 and FIG. 6.

In the present embodiment, the arrangement and role of PTC heater 13 are different from those in the above-described configuration of charging device 10 of the first exemplary embodiment.

In the first exemplary embodiment, PTC heater 13 is adjacent to the casing of battery 11, and directly heats battery 11. In contrast, PTC heater 13 in the present embodiment is adjacent to cooler 16, and heats the cooling medium in cooler 16.

Hereinafter, detailed descriptions will be given. Note that descriptions about the same configuration as that of the first exemplary embodiment will be omitted.

PTC heater 13 is a resistance heater which converts electric power supplied from battery charger 12 into heat and thereby heats the cooling medium in cooler 16. When battery 11 is to be charged or discharged at a low temperature, PTC heater 13 is used to raise the temperature of battery 11. PTC heater 13 is disposed adjacent to cooler 16 so as to sufficiently transfer heat to the cooling medium in cooler 16.

Cooler 16 is a common cooling system which cools both battery 11 and battery charger 12. Cooler 16 is configured to cool battery 11 and battery charger 12 by using a common cooling medium (a coolant in the present embodiment). In the present embodiment, PTC heater 13 can heat the cooling medium flowing through cooler 16.

FIG. 6 is a diagram illustrating a configuration example of cooler 16 of charging device 10 according to the present embodiment.

Cooler 16 is, for example, a cooling system using a coolant as the cooling medium, and includes circulation circuit 16a, pump 16b, and radiator 16c.

In circulation circuit 16a, the cooling medium for exchanging heat with battery 11 and battery charger 12 circulates. In circulation circuit 16a, battery charger 12 and battery 11 are connected in series so that the common cooling medium flows from battery charger 12 to battery 11.

Here, in the present embodiment, PTC heater 13 is arranged adjacent to circulation circuit 16a between battery charger 12 and battery 11. This arrangement is based on the fact that heat generated from PTC heater 13 is higher than heat generated from battery charger 12. However, PTC heater 13 may be arranged upstream of battery charger 12 in the flow of the cooling medium. Alternatively, PTC heater 13 may be simply arranged adjacent to circulation circuit 16a, or may be attached to circulation circuit 16a by a heat-conducting material, such as a heat dissipation binder.

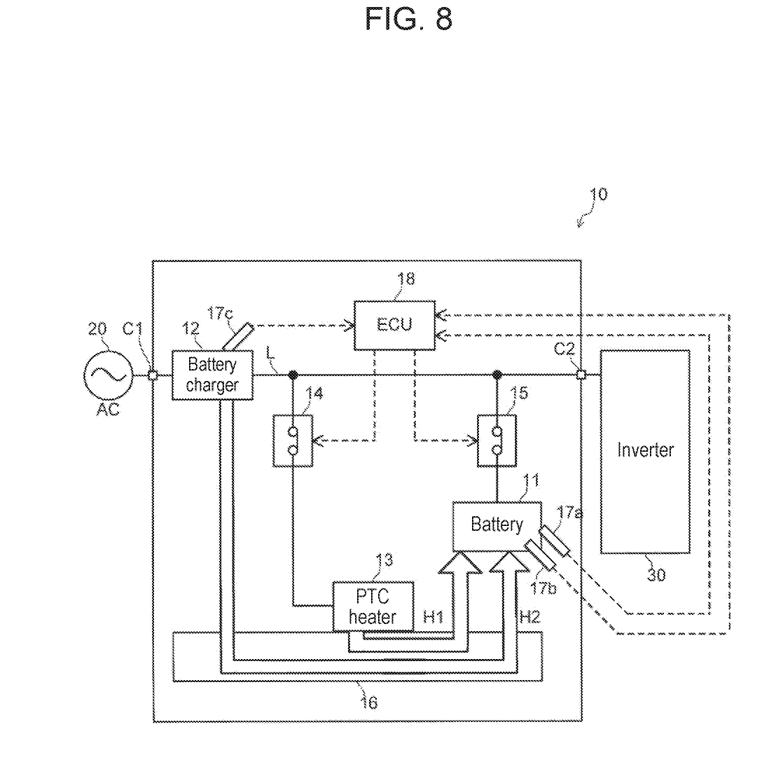

Cooler 16 functions as a heat-transfer mechanism configured to, when battery 11 is to be charged under a low temperature environment (for example, at 0° C. or lower), transmit heat generated in battery charger 12 to battery 11 via the cooling medium to raise the temperature of battery 11, before or immediately after the start of charging (see FIG. 8). In addition, electric power supplied from battery charger 12 is converted into heat by PTC heater 13, and heat generated in PTC heater 13 is also transmitted to battery 11 via the cooling medium.

In other words, the cooling medium is heated by heat generated in battery charger 12, and furthermore, heated by PTC heater 13, and subsequently circulated to battery 11. Then, battery 11 is heated by heat exchange between heat sink 11a of battery 11 and the cooling medium.

### Operation of Charging Device

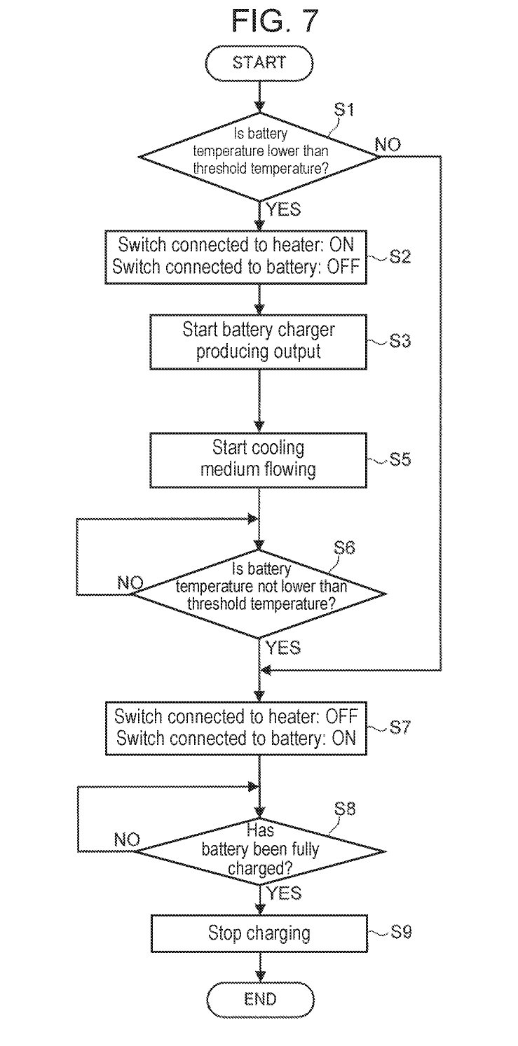

Hereinafter, an operation example of charging device 10 according to the present embodiment will be described with reference to FIG. 7 and FIG. 8.

FIG. 7 is a flow chart illustrating an example of operation of charging device 10 according to the present embodiment. The flow chart in FIG. 7 illustrates an operation performed by ECU 18 in accordance with a computer program, for example. This operation is performed, for example, when a connecting plug of external power source 20 is connected to perform charging of battery 11.

FIG. 8 is a schematic diagram illustrating heat transfer paths taken when charging device 10 according to the present embodiment charges battery 11 under a low temperature environment. Note that, in FIG. 8, H1 refers to a path for transferring heat from PTC heater 13 to battery 11 via the cooling medium, and H2 refers to a path for transferring heat from battery charger 12 to battery 11 via the cooling medium.

From the viewpoints of energy efficiency and chargeable electric power, when charging battery 11 under a low temperature environment, charging device 10 according to the present embodiment starts the charging operation after the temperature of battery 11 has risen to a predetermined temperature. At this time, as described above, charging device 10 raises the temperature of battery 11 by using both heat from PTC heater 13 and heat generated in battery charger 12 (see FIG. 8).

In Step S1, first, ECU 18 determines whether or not the temperature of battery 11 is lower than a threshold temperature (for example, 0° C.), based on, for example, a sensor signal from temperature sensor 17b. When ECU 18 determines that the temperature of battery 11 is lower than the threshold temperature (YES in Step S1), ECU 18 proceeds to perform subsequent Step S2 to raise the temperature of battery 11. In contrast, when ECU 18 determines that the temperature of battery 11 is equal to or higher than the threshold temperature (NO in Step S1), ECU 18 proceeds to perform Step S7 to charge battery 11 as usual.

In Step S2, ECU 18 turns on switch 14 and turns off switch 15 so as to electrically connect battery charger 12 to PTC heater 13.

In Step S3, ECU 18 causes battery charger 12 to start producing output. Thus, PTC heater 13 starts raising the temperature of battery 11. Here, as described above, PTC heater 13 consumes more power at a low temperature, and therefore, compared to the case where electric power is supplied to battery 11 under a low temperature environment, battery charger 12 can produce higher output and accordingly the temperature (exhaust heat) of battery charger 12 is higher.

In Step S5, ECU 18 controls cooler 16 to start flowing the cooling medium. Thus, the cooling medium of cooler 16 transfers the heat generated in battery charger 12 to battery 11 (see FIG. 8). In addition, the cooling medium in cooler 16 transfers the heat generated by PTC heater 13 to battery 11.

In Step S6, ECU 18 waits until the temperature of battery 11 becomes equal to or higher than a threshold temperature (for example, 0° C.) (NO in Step S6). When ECU 18 detects that the temperature of battery 11 becomes equal to or higher than the threshold temperature (YES in Step S6), ECU 18 proceeds to perform subsequent Step S7.

In Step S7, ECU 18 turns off switch 14 and turns on switch 15 so as to electrically connect battery charger 12 to battery 11. Thus, battery 11 starts being charged.

In Step S8, ECU 18 waits until battery 11 is fully charged (NO in Step S8). When ECU 18 detects that battery 11 is fully charged (YES in Step S8), ECU 18 proceeds to perform subsequent Step S9.

In Step S9, ECU 18 stops the output of battery charger 12.

With the above-described flow, ECU 18 makes shorter the time elapsed before battery 11 starts being charged, and also efficiently transfers the heat generated in battery charger 12 to battery 11, when battery 11 is to be charged under a low temperature environment. However, the above-described operation is merely an example, and various modifications may be made. For example, ECU 18 may perform heating of battery 11 and charging of battery 11 at the same time.

As described above, in charging device 10 according to the present embodiment, a common cooling system is shared between battery 11 and battery charger 12, whereby, when battery 11 is to be charged under a low temperature environment, the temperature of battery 11 can be efficiently raised by making use of heat of battery charger 12. Thus, higher energy-efficiency and shorter charging time can be achieved.

Furthermore, in charging device 10 according to the present embodiment, PTC heater 13 does not directly heat battery 11, but heats battery 11 via the cooling medium of cooler 16, and thus, flexibility in the arrangement (layout) of PTC heater 13 can be enhanced.

Specifically, PTC heater 13 is not necessarily arranged adjacent to battery 11, but is only required to be arranged adjacent to cooler 16 (circulation circuit 16a), and accordingly, more options of where to dispose PTC heater 13 are given.

Furthermore, when PTC heater 13 is disposed closer to charging device 10 than battery 11, power wiring from charging device 10 to PTC heater 13 can be made shorter.

The cooling medium is distributed and spread over cooler 16 (circulation circuit 16a) inside battery 11 in order to reduce the temperature variation among a plurality of battery cells that constitute battery 11. Hence, by transferring the heat generated from charging device 10 and PTC heater 13 to battery 11 via the cooling medium, the temperature variation caused when battery 11 is heated can be reduced.

### Third Exemplary Embodiment

### Configuration of Charging Device

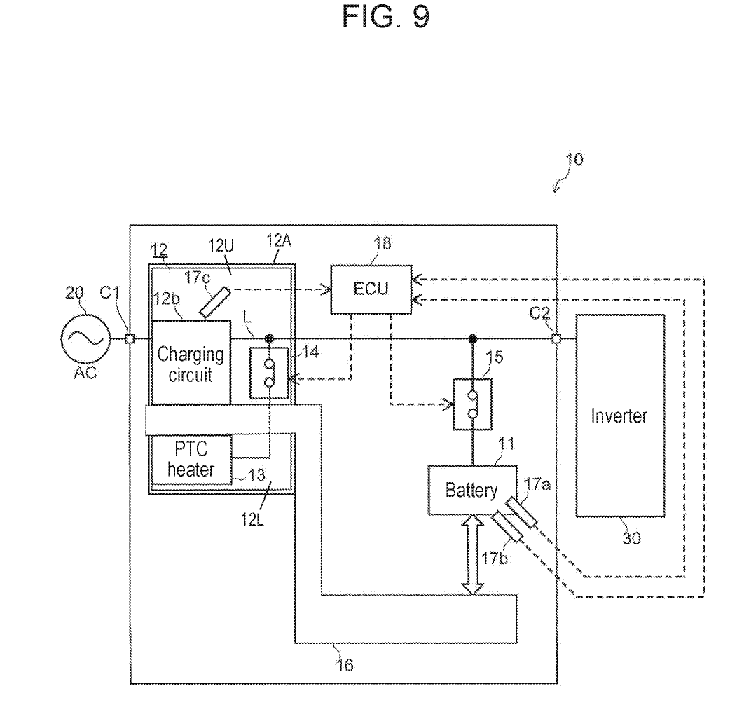

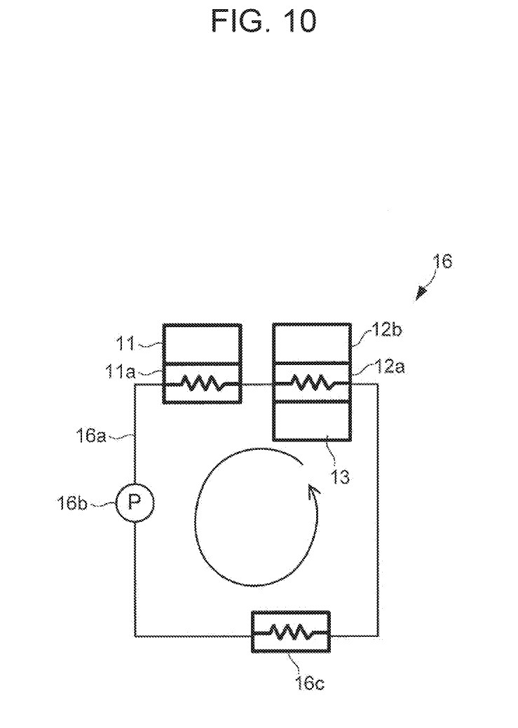

Hereinafter, a configuration example of charging device 10 according to a third exemplary embodiment will be described with reference to FIG. 9 to FIG. 11.

In the present embodiment, PTC heater 13 is adjacent to cooler 16 to heat a cooling medium in cooler 16 as is the case with the second exemplary embodiment, but has an arrangement structure different from that of the second exemplary embodiment.

Hereinafter, detailed descriptions will be given. Note that descriptions about the same configuration as those of the first and second exemplary embodiments will be omitted.

Battery charger 12 includes charging circuit 12b which converts electric power received from external power source 20 and outputs the converted electric power to battery 11 and PTC heater 13.

Charging circuit 12b includes, for example, an AC/DC converter which converts AC power inputted from external power source 20 into DC power, and a DC/DC converter which performs voltage conversion of the DC power.

In addition to charging circuit 12b, PTC heater 13 and switch 14 are accommodated in casing 12A of battery charger 12. Furthermore, cooler 16 (circulation circuit 16a) is disposed so as to penetrate the inside of casing 12A of battery charger 12.

Here, the inside of casing 12A of battery charger 12 is divided into at least two spaces by cooler 16 (circulation circuit 16a). In FIG. 9, the inside of casing 12A is divided into two spaces, for example, an upper space and a lower space. Charging circuit 12b and switch 14 are accommodated in first space 12U, and PTC heater 13 is accommodated in second space 12L.

Note that an opening that connects first space 12U and second space 12L is provided at a position not interfering with cooler 16, and wiring (bus bar) is inserted into this opening so that switch 14 is electrically connected to PTC heater 13.

As is the case with the second exemplary embodiment, PTC heater 13 is a resistance heater that converts electric power supplied from battery charger 12 into heat and thereby heats battery 11. PTC heater 13 heats the cooling medium in cooler 16 under a low temperature environment, and the heated cooling medium circulates into battery 11 to heat battery 11. Similarly, the cooling medium in cooler 16 is heated by heat generated in battery charger 12, and the heated cooling medium circulates into battery 11 to heat battery 11

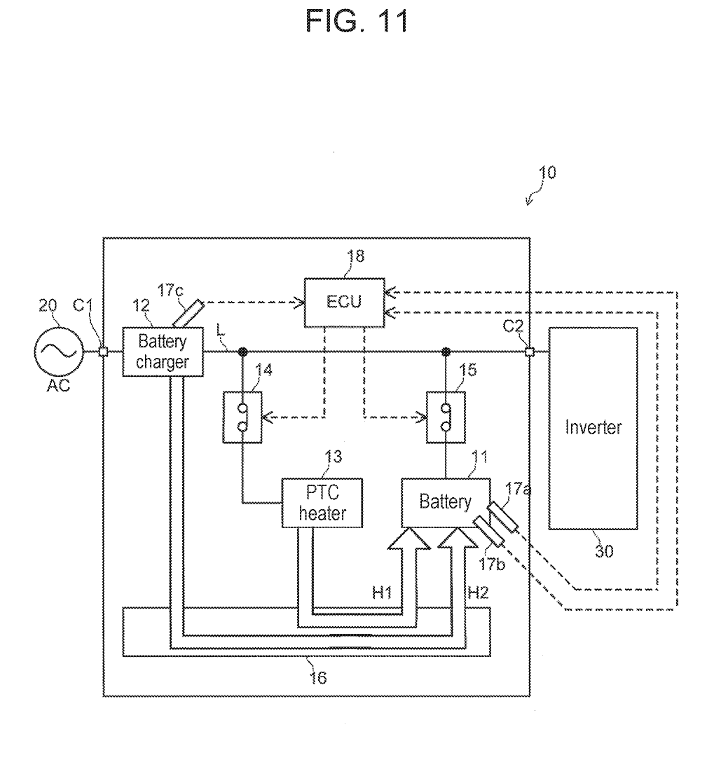

FIG. 11 is a schematic diagram illustrating heat transfer paths taken when charging device 10 according to the present embodiment charges battery 11 under a low temperature environment. Note that, in FIG. 11, H1 refers to a path for transferring heat from PTC heater 13 to battery 11 via the cooling medium, and H2 refers to a path for transferring heat from battery charger 12 to battery 11 via the cooling medium.

From the viewpoints of energy efficiency and chargeable electric power, when battery 11 is to be charged under a low temperature environment, charging device 10 according to the present embodiment starts the charging operation after the temperature of battery 11 has risen to a predetermined temperature. At this time, as described above, charging device 10 raises the temperature of battery 11 by making use of both the heat of PTC heater 13 and the heat generated in battery charger 12. However, the above-described operation is merely an example, and various modifications may be made. For example, ECU 18 may perform heating of battery 11 and charging of battery 11 at the same time.

As described above, in charging device 10 according to the present embodiment, a common cooling system is shared between battery 11 and battery charger 12, whereby, when battery 11 is to be charged under a low temperature environment, the temperature of battery 11 can be efficiently raised by making use of heat of battery charger 12. Thus, higher energy-efficiency and shorter charging time can be achieved.

Furthermore, in charging device 10 according to the present embodiment, in addition to charging circuit 12b, PTC heater 13 and switch 14 are accommodated in casing 12A of battery charger 12, and therefore, it is not necessary to provide an additional casing for housing either or both of PTC heater 13 and switch 14 other than the casing of battery charger 12, and accordingly, size reduction and less man-hour for installation can be achieved.

Furthermore, in charging device 10 according to the present embodiment, in addition to charging circuit 12b, PTC heater 13 and switch 14 are accommodated in casing 12A of battery charger 12. Therefore, wiring between charging circuit 12b and PTC heater 13 can be reduced. Furthermore, charging circuit 12b, PTC heater 13, and switch 14 are accommodated in one and the same casing 12A, and thus, protection for wiring between charging circuit 12b and PTC heater 13 and anti-noise measures can be easily provided.

Furthermore, in charging device 10 according to the present embodiment, cooler 16 (circulation circuit 16a) is disposed so as to penetrate casing 12A of battery charger 12, and accordingly the inside of casing 12A of battery charger 12 is divided into at least two spaces by cooler 16 (circulation circuit 16a). First space 12U accommodates charging circuit 12b, and second space 12L accommodates PTC heater 13. Thus, cooler 16 (cooling medium) can be efficiently heated from both sides, and also, a heat transfer area of cooler 16 can be efficiently utilized.

### Other Embodiments

The present disclosure is not limited to the above-described embodiments, and various modifications can be conceived.

In the above-described embodiments, as a target to apply charging device 10, an electric vehicle is exemplified. However, charging device 10 can be installed in hybrid cars, special vehicles, and other various electric apparatuses.

In the above-described embodiments, as external power source 20, a commercial power source is exemplified. However, external power source 20 may be any type of external power source, such as an external power source that outputs three-phase AC power, and an external power source that outputs DC power. In those cases, battery charger 12 is only required to have a circuit configuration in accordance with the type of external power source 20.

In the above-described embodiments, as an example of charging device 10, ECU 18 exercises centralized control. However, in place of the aspect, there may be adopted an aspect in which battery charger 12, switch 14, switch 15, and cooler 16 individually operate. For example, these constituents may be configured to directly receive respective sensor signals from sensors 17a to 17c and operate based on the sensor signals.

In the above-described embodiments, as the sensors, voltage sensor 17a which detects the cell voltage of battery 11, temperature sensor 17b which detects the temperature (for example, the casing temperature) of battery 11, and temperature sensor 17c which detects the temperature (for example, the casing temperature) of battery charger 12 are exemplified. However, besides the above-mentioned sensors, for example, a temperature sensor which detects a temperature of the cooling medium may be provided as a matter of course. Alternatively, a value to be detected by one of the above-mentioned sensors may be indirectly determined by computing values detected by the other sensors. In this case, some of the above-mentioned sensors may be omitted.

Hereinbefore, specific examples of the present disclosure are described in detail, but these are merely exemplifications, and the claims are not limited to these specific examples. Technologies described in the claims also include variations and modifications of the above-described specific examples.

The charging device according to the present disclosure makes it possible to achieve shorter charging time and higher energy efficiency when the charging device charges the battery under a low temperature environment.

What is claimed is:

1. A charging device configured to charge a battery, the charging device comprising:
a battery charger to be connected to an external power source, the battery charger being configured to supply electric power to the battery;
a resistance heater connected to the battery charger, the resistance heater being configured to convert electric power from the battery charger into heat; and
a cooler configured to cause a cooling medium to flow from the battery charger to the battery so as to cool the battery charger and the battery with the cooling medium,
wherein, when the charging device charges the battery under an environment of a predetermined temperature or lower, the battery charger supplies the electric power to the resistance heater, and heat generated in the battery charger is transmitted to the battery via the cooling medium.

2. The charging device according to claim 1,
wherein the cooler includes a circulation circuit for the cooling medium, the circulation circuit being configured to cause the cooling medium to flow from the battery charger to the battery.

3. The charging device according to claim 2,
wherein the resistance heater raises a temperature of the cooling medium by the electric power from the battery charger.

4. The charging device according to claim 3,
wherein, after the temperature of the cooling medium is raised by the heat generated in the battery charger and the heat generated in the resistance heater, the cooling medium flows toward the battery.

5. The charging device according to claim 3,
wherein the battery charger includes a charging circuit, and a casing accommodating the charging circuit and the resistance heater, and
the circulation circuit is disposed so as to penetrate the casing.

6. The charging device according to claim 5,
wherein the circulation circuit divides an interior space of the casing into at least two spaces including a first space and a second space, and
the first space accommodates the charging circuit, and the second space accommodates the resistance heater.

7. The charging device according to claim 2,
wherein the resistance heater raises a temperature of the battery by using the electric power from the battery charger.

8. The charging device according to claim 7,
wherein, when the charging device charges the battery under the environment of the predetermined temperature or lower, the cooler starts flowing the cooling medium in the circulation circuit at a time when a temperature of the battery charger or a temperature of the cooling medium becomes equal to or higher than the temperature of the battery.

9. The charging device according to claim 1,
wherein the resistance heater is a positive temperature coefficient (PTC) heater.

10. The charging device according to claim 1,
wherein, when a temperature of the battery becomes equal to or higher than a threshold temperature, the battery charger stops supplying the electric power to the resistance heater, and starts charging the battery.

11. An onboard power source device, comprising:
the charging device according to claim 1; and
the battery.
